(19) United States
(12) Patent Application Publication
(10) Pub. No.: US 2007/0150638 A1
(43) Pub. Date: Jun. 28, 2007

(54) Changeable USB memory stick

(75) Inventor: Chien-Yuan Chen, Banchiau City (TW)

Correspondence Address: TROXELL LAW OFFICE PLLC;SUITE 1404, 5205 LEESBURG PIKE, FALLS CHURCH, VA, 22041, US

(73) Assignee: Power Data Communications Co., Ltd. & Chien-Yuan CHEN

(21) Appl. No.: 11/315,365

(22) Filed: Dec. 23, 2005

(51) Int. Cl. G06F 13/20

(52) U.S. Cl. 710/313

(57) ABSTRACT

A changeable USB memory stick includes primarily a common bus which is provided with a multi-memory card interface and a USB interface. The common bus is complied with the format of a USB junction, and is provided with a transmission function of a plurality of memories. The USB memory stick can perform a signal access with a USB transmission interface or a multi-memory card transmission interface including an SD transmission interface, an MMC transmission interface, an MS PRO transmission interface, an XD transmission interface, an SM transmission interface, and a CF transmission interface of an electronic device, by interconnecting with a corresponding connection port through the single common bus.

### BACKGROUND OF THE INVENTION

(a) Field of the Invention

The present invention relates to a personal storage device and more particularly to a kind of USB (Universal Serial Bus) memory stick which can perform data access with a USB transmission interface or a multi-memory card transmission interface of an electronic device by interconnecting to a corresponding connection port through a single common bus.

(b) Description of the Prior Art

As the market of small size digital equipment such as a digital camera, a camcorder, an MP3 player, a mobile phone, etc., is getting more and more prosperous, its interior key elements will be directly affected. To correspond with a miniaturization and sophistication of these kinds of products, the development of technology of key elements is also toward miniaturization and chip design, and the circuit board used for configuring these mini IC (Integrated Circuit) elements is also getting smaller and smaller, while its density is getting higher and higher.

Accordingly, a personal storage device such as the memory card (e.g., Smart Media Card, Secure Digital Card, Multi Media Card, Memory Stick Card, Compact Flash Card, extreme Digital Picture card, etc.) or the memory stick (or the personal disk) used for storing video clips, digital pictures, MP3 music and game data for the aforementioned small size digital equipment has become the personal storage carrier of many computer users. Comparing to a disk, the memory card and memory stick are smaller in size, whereas they have a much larger capacity and a faster access speed. Moreover, these two storage devices are not easily got wet or damaged like the disks, thereby allowing many consumers to replace the disks with these two storage devices for carrying.

As a transmission interface used for connecting the memory card is not the same as that used for connecting the memory stick in an electronic device like an ordinary personal computer or notebook computer; the transmission interface for the memory stick is a USB junction, whereas the transmission interface for the memory card is a conduction terminal which is called the golden finger; therefore, a circuit board should be installed with two interfaces corresponding to the USB connection port and the memory card connector respectively, which is rather inconvenient in application.

Moreover, a relationship of connection on schematic diagrams and requirements in circuit engineering (such as the high frequency characteristics, the impedance of elements, the anti-jamming, etc.) should be taken into consideration in the circuit layout on circuit board. On the other hand, installation holes, plugs, positioning holes, and all kinds of elements should be accurately installed on specified positions on the circuit board, in order to facilitate an installation of peripheral equipment and maintain a good effect of venting and heat dissipation. In addition, the layout of terminal pad, through-hole, routing, etc., on the circuit board will affect a quality of reliability, and should also assure that the elements will not collide with each other and can be installed, tuned, and repaired conveniently.

In other words, the miniaturization of digital equipment is primarily dependent upon the installation of internal IC elements and circuit board layout which will be getting more complicated as the increase of functions. However, due to a limitation of narrowness of circuit layout, it is impossible to add more IC elements and wiring layout. Assembling more elements will also cause a drawback that the digital equipment will be enlarged.

Accordingly, if the personal storage device can be designed to have a transmission function of a plurality of memories, and to perform a signal accessing with the USB transmission interface or the transmission interface of a multi-memory card by interconnecting to the corresponding connection port through a single common bus, then the transmission interface (e.g., the USB connection port, the memory card connector, etc.) on the substrate on circuit board of applied electronic device can be simplified, so as to reduce a space occupied by the transmission interface, thereby facilitating a design toward the miniaturization of electronic device.

### SUMMARY OF THE INVENTION

Accordingly, the present invention is to install a common bus on a USB memory stick which is provided with a multi-memory card interface and a USB interface. The common bus conforms to the specification of a USB junction, and is provided with a transmission function for a plurality of memories. The USB memory stick of the present invention can perform a signal access with a USB transmission interface or a multi-memory card transmission interface including an SD (Secure Digital Card) transmission interface, an MMC (Multi Media Card) transmission interface, an MS PRO (Memory Stick PRO Card) transmission interface, an XD (extreme Digital Picture Card) transmission interface, an SM (Smart Media Card) transmission interface, and a CF (Compact Flash Card) transmission interface of an electronic device by interconnecting to a corresponding connection port through the single common bus.

Accordingly, only a single common bus is required for the memory stick itself, and a function of a portion of circuit junctions in the common bus is shared between the multi-memory card interface and the USB interface; therefore, it will not increase a size of memory stick and increase an inconvenience in application. Correspondingly, only a connection port corresponding to the common bus is required to be installed on the electronic device applied with the memory stick, then a data transmission with the memory stick can be performed through the USB transmission interface or the multi-memory card transmission interface, thereby achieving the objects of saving a space of circuit board, simplifying a layout and assembling of the circuit board, increasing an overall reliability, and reducing inventory and cost of logistics.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a structural diagram of basic components of a memory stick of the present invention.

FIG. 2 shows a schematic view of configuration status of a first and a second contact block of the present invention.

FIG. 3 shows a schematic view of configuration status of a first and a second contact block of another implementation of the present invention.

FIG. 4 shows a perspective view of yet another implementation of memory stick of the present invention.

### DETAILED DESCRIPTION OF THE PREFERRED EMBODIMENTS

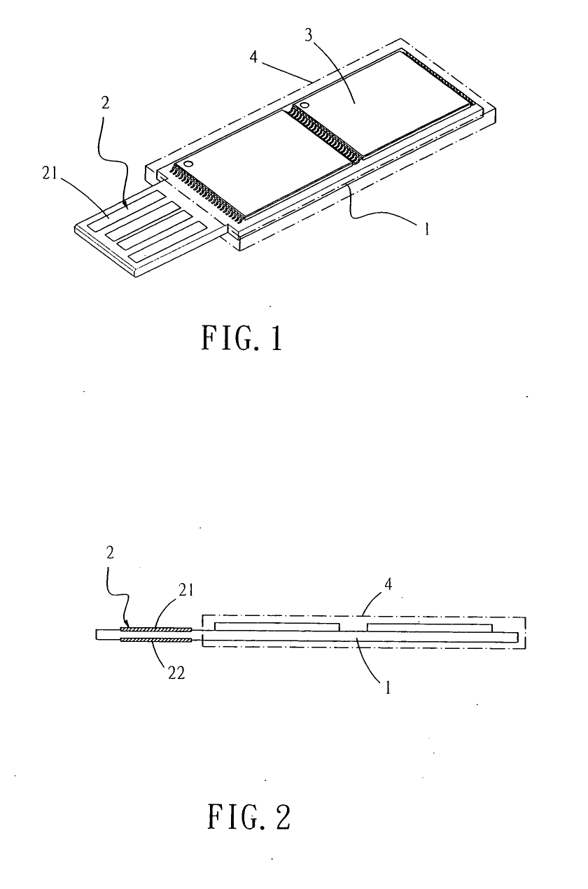

Referring to FIG. 1 and FIG. 2, it shows a structural diagram of basic components of a memory stick of the present invention. The memory stick comprises a substrate 1 which is provided with a common bus 2, a linking wiring, and IC elements including a related control chip, a switch circuit, and a memory module 3. A layer of casing 4 is wrapped on an exterior of the substrate 1 with only the common bus 2 being exposed at an end of the substrate 1, so as to constitute a necessary shielding to the IC elements on the substrate 1.

The common bus 2 is provided with a first circuit contact block 21 and at least a second circuit contact block 22, wherein the configuration of circuit junctions in the first contact block 21 is complied with the corresponding pattern of USB connection port, which is primarily used to enable the memory stick to perform a data transmission with an interconnected electronic device through the USB transmission interface; and some circuit junctions in the second contact block 22 are provided with a specified configuration pattern and are primarily connected with the circuit junctions in the first contact block 21, which are used to enable the memory stick to perform the data transmission with the interconnected electronic device through the multi-memory card transmission interface.

Upon implementing, the first contact block 21 and the second contact block 22 can be installed on an upper and lower board surface of the substrate 1 respectively, as shown in FIG. 2, or can be installed on a front and a rear section of a same board surface of the substrate respectively, as shown FIG. 3, thereby being assembled in the same common bus 2. Therefore, only the single common bus 2 is required to be installed in the whole digital memory stick, and a function of a portion of circuit junctions (circuit junctions of the first contact block 21 are shown in the drawings) is shared between the multi-memory card interface and the USB interface, which will not increase a size of the memory stick and increase an inconvenience in application.

Correspondingly, only a connection port corresponding to the common bus 2 is required to be installed on the electronic device applied with the memory stick, then a data transmission with the memory stick can be performed through the USB transmission interface or the multi-memory card transmission interface, thereby achieving the objects of saving a space of circuit board, simplifying a layout and assembling of the circuit board, increasing an overall reliability, and reducing inventory and cost of logistics.

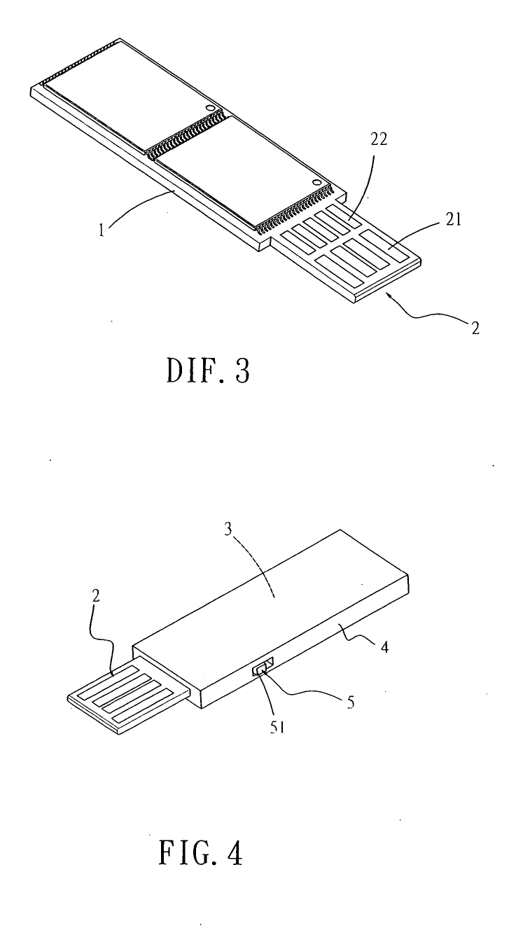

Moreover, as shown in FIG. 4, a switch circuit 5 is used in the present invention to control the memory stick to use the USB interface or the multi-memory card interface in the common bus 2 to perform a data access with a flash memory in the memory module. Upon implementing, the switch circuit 5 can switch between the USB interface and the multi-memory card interface with a manual mode of a switch 51, as shown in the drawing, or can perform an automatic switching between the USB interface and the multi-memory card interface with an installation of a control chip. As this kind of switching technique is well known, it will not be described further.

In addition, the memory stick is provided with a multi-memory card interface including an SD (Secure Digital Card) transmission interface, an MMC (Multi Media Card) transmission interface, an MS PRO (Memory Stick PRO Card) transmission interface, an XD (extreme Digital Picture Card) transmission interface, an SM (Smart Media Card) transmission interface, and a CF (Compact Flash Card) transmission interface, and the substrate of memory stick is further provided with a file management converter to constitute a circuit linking between the switch circuit and the memory module, such that data can be converted to a specified flash memory of the memory module or can be output from the flash memory through the file management converter.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A changeable USB memory stick comprising a common bus which conforms to the format of a USB junction; its improvement being that the common bus is provided with a multi-memory card interface and a USB interface so as to constitute a USB memory stick which is provided with a transmission function for a plurality of memories and can perform a signal access with a USB transmission interface or a multi-memory transmission interface including an SD transmission interface, an MMC transmission interface, an MS PRO transmission interface, an XD transmission interface, an SM transmission interface, and a CF transmission interface of an electronic device by interconnecting with a corresponding connection port through the single common bus.

2. The changeable USB memory stick according to claim 1, wherein the common bus is provided with a first contact block, and at least a second contact block, wherein the configuration of circuit junctions in the first contact block conforms to the corresponding pattern of USB connection port, and some circuit junctions in the second contact block are provided with a specified configuration pattern.

3. The changeable USB memory stick according to claim 2, wherein some circuit junctions in the second contact block are connected with the circuit junctions in the first contact block, so as to enable the memory stick to perform a data transmission with an interconnected electronic device through the multi-memory card transmission interface.

4. The changeable USB memory stick according to claim 1, wherein the first and second contact blocks are located at an upper and a lower board surface of a substrate, respectively.

5. The changeable USB memory stick according to claim 1, wherein the first and second contact blocks are located at a front and a rear position of a same board surface of a substrate, respectively.

6. The changeable USB memory stick according to claim 1, wherein a switch circuit is used to constitute a circuit linking between the common bus and a memory module.

7. The changeable USB memory stick according to claim 6, wherein the switch circuit can switch between the USB interface and the multi-memory card interface through a manual mode of a switch.

8. The changeable USB memory stick according to claim 6, wherein the switch circuit can perform an automatic switching between the USB interface and the multi-memory card interface with an installation of a control chip.

9. The changeable USB memory stick according to claim 1, wherein a switch circuit and a file management converter are used to constitute a circuit linking between the common bus and a memory module.
